(19) United States
(12) Patent Application Publication
(10) Pub. No.: US 2015/0013175 A1
(43) Pub. Date: Jan. 15, 2015

(54) DEVICE AND SYSTEM FOR ALIGNING BEAMS AND HOLDING THEM IN POSITION

(71) Applicant: Micro-Controle-Spectra Physics, Evry Cedex (FR)

(72) Inventors: Eric Durand, Amilly (FR); Alain Jeanne, Amilly (FR)

(21) Appl. No.: 14/376,822

(22) PCT Filed: Feb. 7, 2013
(86) PCT No.: PCT/FR2013/050253

§ 371 Date: Aug. 5, 2014

(30) Foreign Application Priority Data
Feb. 13, 2012 (FR) 1251300

(51) Int. Cl. G01B 5/25

(52) U.S. Cl. CPC G01B 5/25
USPC 33/286

(57) ABSTRACT

The device (3) comprises a frame (6), a support piece (7) which is movable with respect to said frame (6) and which exhibits a master side provided with a rigid blade (9), on which may be fixed a first beam (2), and a slave side provided with two rollers, on which can rest an element for holding a second beam (2), and a set of actuators (13), which are able to position the movable support piece (7) in translation along two axes, termed the vertical axis and transverse axis respectively, which are perpendicular to one another and to a longitudinal axis, and in rotation about said longitudinal axis, so as to adjust the position of the first beam, the second beam following the translational motion along said two vertical and transverse axes.

The present invention relates to a device for aligning two beams longitudinally along a reference axis, and a system for aligning a plurality of beams, in which two successive beams are interconnected in each case by an alignment device of this type.

Although not exclusively, said alignment device can be used more particularly for the purpose of aligning two laser beams in opposite directions in a precise manner. In this case, each laser beam is transmitted by means which are respectively arranged on one of the two beams to be aligned.

In this application, the alignment device therefore has to be capable of ensuring that the beams used for support are held in position and are angularly aligned in a precise manner. By way of example, the sensitivity of the device should allow the laser beam to be aligned within 10 μm. In addition, the means used for transmitting a laser beam are heavy so that each beam should be able to bear a heavy load, sometimes of several kilograms, meaning that particular capacities are required for the alignment system.

The object of the present invention is to meet these requirements. The invention firstly relates to a device for aligning two beams longitudinally along a reference direction, and for holding the two aligned beams in position, which device can be used in an application of the type described above.

For this purpose, according to the invention, said device for aligning two beams longitudinally along a reference direction, and for holding the two beams in position, is distinctive in that it comprises:
a frame which is intended to be mounted on a stationary installation, or which can be part of a stationary installation;
a support part which is movable relative to said frame and which has a master side which is provided with a rigid sheet, on which a first of said beams can be fixed, and a slave side provided with two wheels, on which an element for holding the second of said beams can rest; and
an assembly of controllable actuators, mounted in parallel between the frame and the movable support part, which can position said movable support part in translation along two axes, referred to respectively as a vertical axis and a transverse axis, which are perpendicular to one another and to a longitudinal axis, and in rotation about said longitudinal axis, so as to adjust the position of said first beam on the master side, the second beam on the slave side following the movement in translation along said two vertical and transverse axes during adjustment of this type of the position.

In addition, according to the invention, this device allows decoupling along the longitudinal axis and about the vertical and transverse axes.

As a result, the alignment device according to the invention is as follows:
on the master side, it transmits the displacement in the vertical and transverse directions and about the longitudinal direction, and it allows decoupling along the longitudinal direction and about the vertical and transverse directions; and
on the slave side, it forces the beam to follow the movements in the vertical and transverse directions, and it allows decoupling along the longitudinal direction and about the longitudinal, vertical and transverse directions.

Therefore, by means of the invention, and as specified below, a device is obtained which is simple, easy to produce and allows the implementation of a precise alignment of two beams which may be heavy.

This device, of the parallel robot type, makes it possible to optimise the rigidity and the frequency of the movable support part, while avoiding the use of guidance systems. It has many other advantages specified below.

In a preferred embodiment, said alignment device comprises three linear actuators, which are identical and mounted so as to be able to carry out the positioning of the movable support part. Using actuators which are identical (in terms of load, precision, travel and interface) has many advantages, in particular in terms of cost, production, maintenance, etc.

In this case, advantageously, two linear actuators are arranged on either side of the longitudinal axis, in a direction which is parallel to the vertical axis, and the third linear actuator is arranged in a direction which is parallel to the transverse axis, the arrangement being such that it generates a combination of movement which ends in a rotation about a pivot point.

In addition, each actuator preferably comprises:
a simple and rigid kinematic chain; and
at each end of the kinematic chain, a decoupling such as a flexible sheet pivot, which makes it possible to ensure that the assembly is mounted in an isostatic manner and has great rigidity.

Moreover, advantageously, said rigid sheet is generally diamond shaped. In addition, said sheet is fixed on the support part at two opposing peaks along the transverse direction, and it has two fixing regions at the two other opposing peaks which allow the beam to be fixed in a vertical direction.

The present invention also relates to a construction module provided with two beams which are aligned longitudinally along a reference axis.

According to the invention, this construction module comprises an alignment device of the above-mentioned type, and two beams, a first of which is fixed to the rigid sheet on the master side of said alignment device, and the second of which comprises a holding element, preferably a cylindrical track which is concentric with the reference axis of the beam, which rests on the two wheels on the slave side of said alignment device.

In addition, advantageously, said construction module also comprises at least one axial return bar, which is connected at one end to a beam and at the other end to the alignment device.

The present invention also relates to a system for aligning a plurality of successive beams.

According to the invention, said alignment system is distinctive in that it comprises, in addition to said beams, a plurality of alignment devices of the above-mentioned type, and in that an alignment device of this type is arranged in each case between two directly successive beams.

Furthermore, advantageously, said system comprises, in addition, a plurality of axial return bars, each of which is connected at one end to a beam and at the other end to an adjacent alignment device by articulation means.

The alignment system according to the invention is therefore a modular system consisting of beams and alignment devices. Each alignment device makes it possible to angularly adjust the reference axes of two successive beams and then keep them aligned. Said system allows very precise alignment.

The present invention as described above has in particular the following advantages:
a simple (kinematic) design;
the ability to produce and assemble mechanical parts;
improved performance (in terms of sensitivity and rigidity); and
good holding ability.

The figures of the accompanying drawings will provide better understanding of how the invention can be produced. In these drawings, identical reference numerals denote like elements.

FIG. 1 is a schematic, perspective view of a system according to the invention.

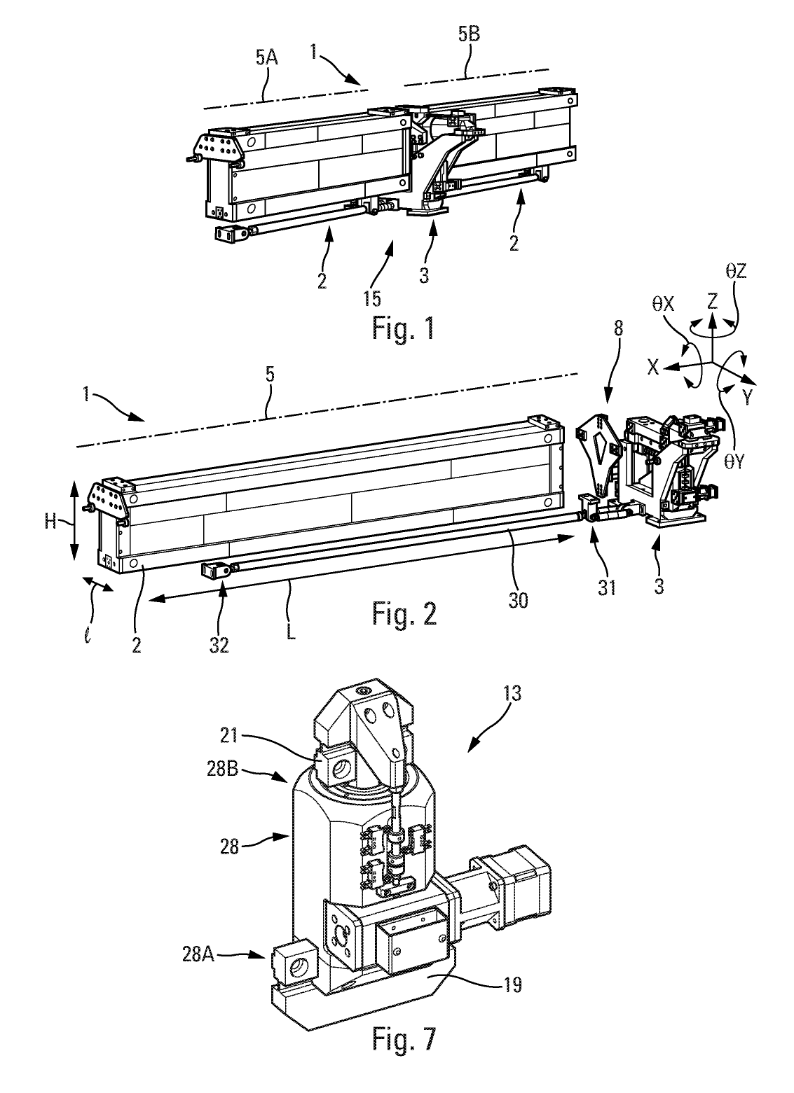

FIG. 2 is a schematic, perspective view of the elements of a system according to the invention.

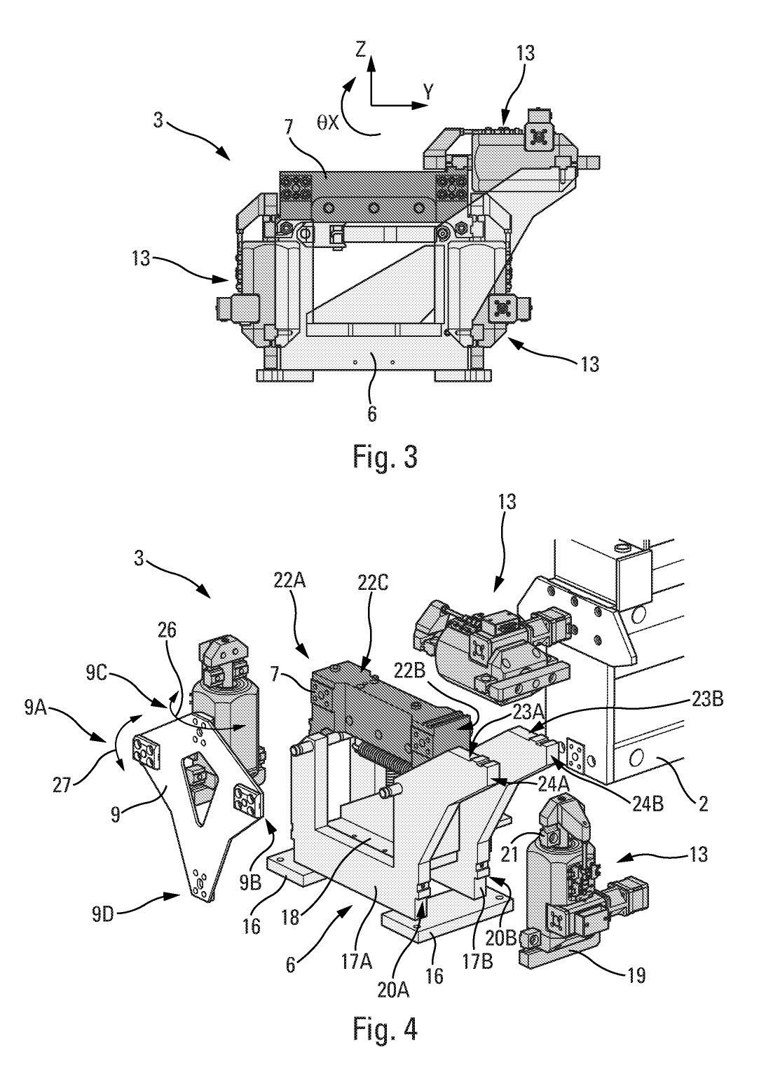

FIG. 3 is a schematic, plan view of an alignment device according to the invention.

FIG. 4 is an exploded perspective view of an alignment device according to the invention.

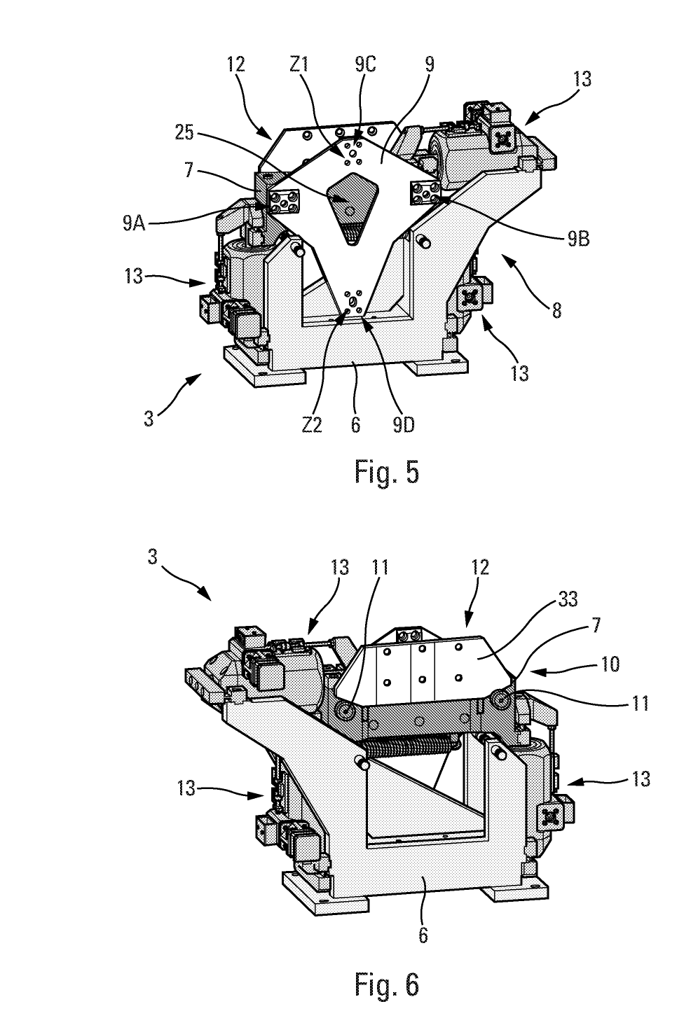

FIGS. 5 and 6 are perspective views of an alignment device according to the invention, from a master side and a slave side respectively.

FIG. 7 is a schematic, perspective view of an actuator of a device according to the invention.

The system 1 according to the invention and shown schematically in FIG. 1 is a system for aligning two successive beams 2, which are preferably identical, and holding them in position.

In the context of the present invention, each beam 2 is produced in the form of a rectangular parallelepiped (hexahedron, the faces of which are rectangles and are in parallel two by two), as shown in FIG. 2. By way of example, the length L of a beam 2 can be two metres, the thickness l can be approximately ten centimetres and the height H can be approximately several tens of centimetres. Each beam 2 is produced from a rigid material so that said beam can bear high loads acting vertically, without deforming or with continuous deformation within very low limits.

Although not exclusively, this alignment system 1 can be used more particularly for the purpose of aligning two laser beams 5A and 5B in opposite directions in a precise manner.

The alignment system 1 has to ensure that the support beams 2 are held in position and are angularly aligned in a precise manner.

As shown in FIG. 1, in the system 1, two beams 2 are interconnected by an alignment device 3 according to the invention, as described below.

The alignment device 3 therefore carries an end of two successive beams 2 and makes it possible to angularly adjust the reference axes 5A and 5B of said two successive beams 2 and then keep them aligned. A reference axis 5 of this type, which is shown as a dash-dotted line in FIG. 2, is positioned so as to coincide with the axis of the corresponding laser beam in the case of an alignment of laser beams.

For this purpose, the alignment device 3 comprises, according to the invention, as shown in FIG. 3:
a frame 6, preferably made of metal, which is intended to be mounted on a stationary installation, on a planar horizontal surface, in particular on the ground. Said frame 6 can also directly be part of a stationary installation;
a support part 7, preferably made of metal, which is mounted so as to be movable relative to said frame 6 and which has a master side 8 (FIG. 5) provided with a rigid sheet 9, on which a first of said beams 2 can be fixed, and a slave side 10 (FIG. 6) provided with two wheels 11, on which an element 12 for holding the second of said beams 2 can rest; and
an assembly of controllable actuators 13, mounted in parallel between the frame 6 and the movable support part 7, which can position said movable support part 7 in the manner described below.

In order to make this positioning more precise, axes which are involved in the adjustment of the position are firstly defined, as shown in FIGS. 2 and 3, that is to say:
a longitudinal axis X which is defined in the direction of the reference axis 5;
a transverse axis Y which is perpendicular to said longitudinal axis X, said axes X and Y defining a horizontal plane; and
a vertical axis Z which is perpendicular to said longitudinal axis X and to said transverse axis Y.

The rotations about said axes X, Y and Z are respectively marked ΘX, ΘY and ΘZ.

According to the invention, the actuators 13 can position said movable support part 7 (relative to said frame 6) so as to adjust the position of said first beam 2 on the master side 8:
in translation along the vertical axis Z and along the transverse axis Y; and
in rotation ΘX about the longitudinal axis X.

During an adjustment of this type of the position of the master side 8, due to the features of the device 3, the second beam 2 on the slave side 10 is forced to follow the movement in translation along said two transverse and vertical axes Y and Z.

In addition, said device 3 allows:
on the master side 8, decoupling along the longitudinal axis X and about the transverse and vertical axes, that is to say according to ΘY and ΘZ; and
on the slave side 10, decoupling along the longitudinal axis X, and about the longitudinal, transverse and vertical axes, that is to say according to ΘX, ΘY and ΘZ.

As a result, the alignment device 3 according to the invention is as follows:
on the master side 8, the beam 2 is fixed on the rigid sheet 9 which transmits the displacement in the directions Y, Z and ΘX and allows decoupling along the directions X, ΘY and ΘZ; and
on the slave side 10, the arrangement of the holding element 12, specified below, forces the beam 2 to follow the movements in the directions Y and Z and allows decoupling along the directions X, ΘX, ΘY and ΘZ.

Therefore, by means of the invention, a device 3 is obtained which is simple, easy to produce and allows the implementation of a precise alignment of two beams 2 as described above, which may be heavy.

This device 3, of the parallel robot type, makes it possible to optimise the rigidity and the frequency of the movable support part 7, while avoiding the use of the guidance systems. It has many other advantages specified below.

An alignment device 3 according to the invention forms a construction module 15 with the two adjacent beams 2.

In a preferred embodiment, as shown in the exploded view in FIG. 4, the frame 6 which is intended to be mounted in a stationary manner comprises for example two feet 16 which are planar and can rest on a planar horizontal surface, in particular on the ground. This frame 6 comprises two planar plates 17A, 17B, which are generally U shaped and are vertically mounted in a symmetrical manner and are fixed to one another by means in particular of the feet 16 and a lower horizontal plate 18. This makes it possible in particular to obtain a particularly rigid frame 6.

In addition, the movable part 7 is produced as a solid part, having a generally parallelepipedal shape. Said part is mounted between the two plates 17A and 17B of the frame 6, by means of the actuators 13.

In a preferred embodiment, said alignment device 3 comprises three actuators 13 of the linear type, that is to say which only generate an axial action. These three actuators 13 are identical and are mounted so as to be able to produce the positioning as described above of the support part 7 which is movable relative to the frame 6.

In this case, two linear actuators 13 are arranged on either side of a plane formed by the longitudinal axis X and the vertical axis Z and are mounted vertically so that they each act in a direction which is parallel to the vertical axis Z. In addition, each of these actuators 13 is fixed:
by means of a first flexible sheet 19 to the external faces 20A and 20B of the two plates 17A and 17B, preferably by screws; and
by means of a second flexible sheet 21 to the external face 22A, 22B of the movable part 7, preferably also by means of screws.

In addition, the third linear actuator 13 is arranged to as to act in a direction which is parallel to the transverse axis Y. For this purpose, said actuator 13 is fixed:
by means of a first flexible sheet 19 to the upper faces 23A and 23B of extensions 24A and 24B of the two plates 17A and 17B, preferably by screws; and
by means of a second flexible sheet 21 on the upper face 22C of the movable part 7, preferably also by screws.

Moreover, as shown in particular in FIG. 5 which is a perspective view of the device 3 from the master side 8, said rigid sheet 9 is generally diamond shaped and has a central cutout 25. Said rigid sheet 9 is fixed on the support part 7 at two opposing peaks 9A and 9B along the transverse direction Y, by a screw assembly. In addition, said sheet has two fixing regions Z1 and Z2 at the two other opposing peaks 9C and 9D which allow the beam 2 to be fixed in the vertical direction Z.

This rigid sheet 9 has a certain degree of flexibility in the vertical and transverse directions, as shown respectively by the double arrows 26 and 27 in FIG. 4.

In addition, as shown in particular in FIG. 6, which is a perspective view of the device 3 from the slave side 10, said holding element 12 (which is fixed on the beam 2, preferably by screws) comprises a cylindrical track 33 which is concentric with the reference axis and which rests on the two wheels 11 of the support part 7 in order to force the beam 2 to follow the movements in the directions Y and Z and allow decoupling in the directions X, ΘX, ΘY and ΘZ.

Moreover, in a preferred embodiment, each actuator 13 comprises, as shown in FIG. 7:
a simple and rigid kinematic chain 28, in particular having roller screws and a roller bearing; and
at one end 28A of said kinematic chain 28, a flexible sheet 19 pivot and, at the other end 28B of the kinematic chain 28, a flexible sheet 21 pivot, which make it possible to ensure that the assembly is mounted in an isostatic manner and has great rigidity.

The flexible sheets 19 and 21 are such that they can be held in traction in order to ensure the stability of the assembly.

An actuator 13 is thereby obtained which is particularly rigid and makes it possible in particular to obtain the abilities required for the above-mentioned application.

In addition, using actuators 13 which are identical (in terms of load, precision, travel and interface) has many advantages, in particular in terms of cost, production, maintenance, etc.

Moreover, said system 1 of the modular type can be used to align a high number of successive beams 2. In the case of aligning more than two successive beams 2, while mounting the modular system 1, the adjustment of the position is started at one end of the system 1, and successive alignments of the beams 2, beam 2 after beam 2, are carried out up to the other end of the system 1.

In the system 1, each beam 2 is thus fixed between two alignment devices 3 by a master side and a slave side, that is to say:
on the master side, the beam 2 is fixed on a rigid sheet 9 which transmits the displacement in the directions Y, Z and ΘX and allows decoupling along the directions X, ΘY and ΘZ; and
on the slave side, the holding element 12 forces the beam 2 to follow the movements in the directions Y and Z and allows decoupling along the directions X, ΘX, ΘY and ΘZ.

In this case, the system 1 thus also comprises a plurality of axial return bars 30, each of which is mounted between a beam 2 and an adjacent alignment device 3, respectively by conventional articulation means 31 and 32. Each bar 30 makes it possible to ensure that the beam 2 (to which said bar is fixed) is held in position and is axially rigid along the longitudinal direction X.

The system 1 according to the invention, as described above in a preferred embodiment, has in particular the following advantages:
a simple (kinematic) design;
the ability to produce and assemble mechanical parts;
improved performance (in terms of sensitivity and rigidity); and
reliable holding ability.

1. Device for aligning two beams longitudinally along a reference direction, and for holding the two beams in position, wherein it comprises:
a frame;
a support part which is movable relative to said frame and which has a master side provided with a rigid sheet, on which a first of said beams can be fixed, and a slave side provided with two wheels, on which an element for holding the second of said beams can rest; and
an assembly of controllable actuators, mounted in parallel between the frame and the movable support part, in order to position said movable support part in translation along two axes, referred to respectively as a vertical axis and a transverse axis, which are perpendicular to one another and to a longitudinal axis, and in rotation about said longitudinal axis, in order to adjust the position of said first beam on the master side, the second beam on the slave side following the movement in translation along said two vertical and transverse axes during an adjustment of the position.

2. Device according to claim 1, wherein it comprises three linear actuators, wherein two linear actuators are arranged on either side of a plane formed by the longitudinal axis and the vertical axis and are mounted vertically so that they each act in a direction which is parallel to the vertical axis, and wherein the third linear actuator is arranged so as to act in a direction which is parallel to the transverse axis.

3. Device according to claim 1, wherein said actuators are identical.

4. Device according to claim 1, wherein each actuator comprises:
a kinematic chain; and
at each end of the kinematic chain, a decoupling.

5. Device according to claim 1, wherein said rigid sheet is generally diamond shaped, it is fixed on the support part at two opposing peaks along the transverse direction, and it has two fixing regions at the two other opposing peaks which allow the beam to be fixed in the vertical direction.

6. Construction module provided with two beams which are longitudinally aligned along a reference axis, wherein it comprises an alignment device of the type specified in claim 1, and two beams, a first of which is fixed to the rigid sheet on the master side of said alignment device and a second of which comprises a holding element which rests on the two wheels on the slave side of said alignment device.

7. Construction module according to claim 6, wherein said holding element comprises a cylindrical track which is concentric with the reference axis.

8. Construction module according to claim 6, wherein it comprises, additionally, at least one axial return bar which is connected at one end to a beam and at the other end to the alignment device.

9. System for aligning a plurality of successive beams, wherein it comprises, in addition to said beams, a plurality of alignment devices of the type specified in claim 1, and wherein one of said alignment devices is arranged in each case between two successive beams.

10. System according to claim 9, wherein it comprises, additionally, a plurality of axial return bars, each of which is connected at one end to a beam and at the other end to an adjacent alignment device.
